(19) United States
(12) Patent Application Publication
(10) Pub. No.: US 2025/0150773 A1
(43) Pub. Date: May 8, 2025

(54) SOUND FIELD ROTATION

(71) Applicant: DOLBY LABORATORIES LICENSING CORPORATION

(72) Inventor: David S. MCGRATH, Rose Bay (AU)

(73) Assignee: DOLBY LABORATORIES LICENSING CORPORATION, (US)

(21) Appl. No.: 18/833,065

(22) PCT Filed: Jan. 25, 2023
(86) PCT No.: PCT/US2023/011534

§ 371 Date: Jul. 25, 2024

Related U.S. Application Data
(60) Provisional application No. 63/303,201, filed on Jan. 26, 2022.
(60) Provisional application No. 63/479,078, filed on Jan. 9, 2023.

(51) Int. Cl. H04S 7/00

(52) U.S. Cl. CPC H04S 7/304; H04S 2400/11

(57) ABSTRACT

Methods, systems, and media for determining sound field rotations are provided. In some embodiments, a method for determining sound field rotations involves determining an activity situation of a user. The method may involve determining a user head orientation using at least one sensor of the one or more sensors. The method may involve determining a direction of interest based on the activity situation and the user head orientation. The method may involve determining a rotation of a sound field used to present audio objects via headphones based on the direction of interest.

### CROSS-REFERENCE TO RELATED APPLICATIONS

This application claims the benefit of priority from U.S. 63/303,201, filed on 26 Jan. 2022 and U.S. Provisional Patent Application No. 63/479,078, filed on 9 Jan. 2023, each one incorporated by reference in their entirety.

### TECHNICAL FIELD

This disclosure pertains to systems, methods, and media for sound field rotation.

### BACKGROUND

Audio content that is intended to be presented with various spatial contexts may be difficult to render, e.g., in an instance in which a user is wearing headphones and moving. Inaccurately rendering such audio content may be undesirable, as it may cause a jarring experience of the listener.

### NOTATION AND NOMENCLATURE

Throughout this disclosure, including in the claims, the terms “speaker,” “loudspeaker” and “audio reproduction transducer” are used synonymously to denote any sound-emitting transducer (or set of transducers). A typical set of headphones includes two speakers. A speaker may be implemented to include multiple transducers (e.g., a woofer and a tweeter), which may be driven by a single, common speaker feed or multiple speaker feeds. In some examples, the speaker feed(s) may undergo different processing in different circuitry branches coupled to the different transducers.

Throughout this disclosure, including in the claims, the expression performing an operation “on” a signal or data (e.g., filtering, scaling, transforming, or applying gain to, the signal or data) is used in a broad sense to denote performing the operation directly on the signal or data, or on a processed version of the signal or data (e.g., on a version of the signal that has undergone preliminary filtering or pre-processing prior to performance of the operation thereon).

Throughout this disclosure including in the claims, the expression “system” is used in a broad sense to denote a device, system, or subsystem. For example, a subsystem that implements a decoder may be referred to as a decoder system, and a system including such a subsystem (e.g., a system that generates X output signals in response to multiple inputs, in which the subsystem generates M of the inputs and the other X-M inputs are received from an external source) may also be referred to as a decoder system.

Throughout this disclosure including in the claims, the term “processor” is used in a broad sense to denote a system or device programmable or otherwise configurable (e.g., with software or firmware) to perform operations on data (e.g., audio, or video or other image data). Examples of processors include a field-programmable gate array (or other configurable integrated circuit or chip set), a digital signal processor programmed and/or otherwise configured to perform pipelined processing on audio or other sound data, a programmable general purpose processor or computer, and a programmable microprocessor chip or chip set.

### SUMMARY

Methods, systems, and media for determining sound field rotations are provided. In some embodiments, a method for determining sound field rotations may involve: (a) determining an activity situation of a user; (b) determining a user head orientation using at least one sensor of the one or more sensors; (c) determining a direction of interest based on the activity situation and the user head orientation; and (d) determining a rotation of a sound field used to present audio objects via headphones based on the direction of interest.

In some examples, the method may further involve (e) repeating (a)-(d) such that the rotation of the sound field is updated over time based on changes in the activity situation of the user and the user head orientation.

In some examples, the activity situation comprises at least one of: walking, running, non-walking and non-running movement, or minimal movement. In some examples, the activity situation comprises walking or running, and wherein the direction of interest is determined based on the direction in which the user is walking or running. In some examples, the activity situation comprises non-walking and non-running movement, and wherein the direction of interest is determined based on a direction the user has been facing within a predetermined previous time window. In some examples, the predetermined previous time window is within a range of about 0.2 seconds to 3 seconds. In some examples, the activity situation comprises minimal movement, and wherein the direction of interest is determined based on a direction the user has been facing within a predetermined previous time window. In some examples, the predetermined previous time window is longer than a predetermined previous time window used to determine the direction of interest associated with an activity situation of non-walking and non-running movement. In some examples, the predetermined previous time window used to determine direction of interest associated with an activity situation of minimal movement is within a range of about 3 seconds to 10 seconds. In some examples, the direction the user has been facing is determined using a tolerated threshold of movement, and wherein the tolerated threshold of movement is within a range of about 2 degrees to 20 degrees. In some examples, the rotation of the sound field involves an incremental rotation toward the direction of interest. In some examples, the incremental rotation is based at least in part on angular velocity measurements obtained from a user device. In some examples, the user device is substantially static in movement with respect to the headphones worn by the user. In some examples, the user device provides audio content to the headphones.

In some examples, the activity situation of the user is determined based at least upon sensor data obtained from one or more sensors disposed in or on headphones worn by the user.

In some examples, the user head orientation is determined using at least one sensor disposed in or on headphones worn by the user.

In some examples, the headphones comprise ear buds.

In some examples, the method further involves after (d), causing the audio objects to be rendered based on the determined rotation of the sound field. In some examples, the method further involves causing the rendered audio objects to be presented via the headphones.

In some embodiments, an apparatus is provided, wherein the apparatus is configured for implementing any of the above methods.

In some embodiments, one or more non-transitory media having software stored thereon are provided, wherein the software is configured to perform any of the above methods.

### BRIEF DESCRIPTION OF THE DRAWINGS

FIG. 1 is schematic diagram for a system for sound field rotation in accordance with some embodiments.

FIG. 2 is a schematic diagram for a system for determining a sound field orientation based on an activity situation in accordance with some embodiments.

FIG. 3 is a flowchart of an example process for determining a manner in which to rotate a sound field based on a user head orientation in accordance with some embodiments.

FIG. 4 is a flowchart of an example process for determining a sound field orientation based on an activity situation in accordance with some embodiments.

FIG. 5 is an example graph illustrating sound field orientations for various activity situations in accordance with some embodiments.

FIG. 6 is a flowchart of an example process for determining a sound field orientation in a static activity situation in accordance with some embodiments.

FIG. 7 shows a block diagram that illustrates examples of components of an apparatus capable of implementing various aspects of this disclosure.

Like reference numbers and designations in the various drawings indicate like elements.

### DETAILED DESCRIPTION OF EMBODIMENTS

Audio content may be scene-based. For example, an audio content creator may create audio content that includes various audio objects intended to be rendered and played back to create a perception of being in a particular spatial location with respect to the user. By way of example, audio content may include primary vocals that are intended to be perceived as being “in front” of the listener. Additionally or alternatively, the audio content may include various audio objects (e.g., secondary instruments, sound effects, etc.) that are intended to be perceived as being to the side of the listener, above the listener, etc. Achieving spatial presentation of audio objects that adheres to the intent of the audio creator may be difficult, particularly when the audio content is being rendered to and/or presented by headphones. For example, when a listener is wearing headphones, they may move their head in various ways (e.g., to look at things) and/or more their body in ways that in turn change their head orientation. Moreover, rendering audio content to strictly follow the user's head orientation when the user is moving may cause unintended perceptual consequences. For example, in an instance in which the user is walking or running, the user may occasionally turn their head, e.g., to check for cars when crossing a street or to otherwise look around. Continuing with this example, rotating a sound field to correspond with the user's head orientation changes may be jarring for the listener, and it may be desirable in such a situation to continue rendering audio objects intended to be “in front” of the listener in a manner that is perceived as in front of the listener's body (e.g., the direction they are walking or running) even when the listener occasionally turns their head away from the direction of the movement. Conversely, in an example in which the user is not moving forward in a linear and/or substantially forward manner (e.g., when performing household chores, and/or engaged in another activity that involves frequent twists and/or turns in various directions), it may be desirable to rotate the sound field to correspond with the user's head orientation.

Disclosed herein are techniques for determining sound field rotations based on an activity situation of the listener. In some embodiments, a current activity situation of the listener may be determined. As used herein, an “activity situation” refers to a characterization of a current activity the user is engaged in, and, in particular, a characterization of the user movement of the current activity. Example activity situations include: walking, running, or other movement that involves substantially linear or forward movement; minimal movement; and non-walking or non-running movement. Note that the term “listening situation” is used interchangeably herein with the term “activity situation.” The activity situation may be determined based on one or more sensors disposed in or on headphones worn by the user. The headphones may be over the head headphones, ear buds, or the like. A direction of interest of the listener may be determined. As used herein, a “direction of interest” refers to an azimuthal angle with respect to a vertical axis pointing out of the user's head that corresponds to a target azimuthal orientation of the sound field. The direction of interest may depend on the current activity situation the listener is engaged in. For example, for a given user head orientation, the direction of interest may be different if the user is walking or running compared to if the user is in a minimal movement activity situation. Rotation information may then be determined to cause audio objects to be presented based on the user's current orientation, and the direction of interest (which is in turn dependent on the current activity situation). The rotation information may be determined such that the sound field is rotated toward the direction of interest in a smooth manner, thereby avoiding sudden discontinuities in the rendering of audio objects.

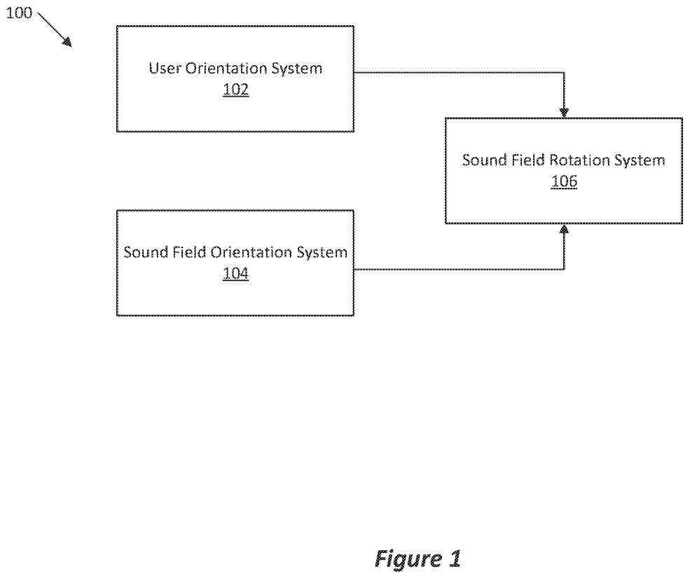

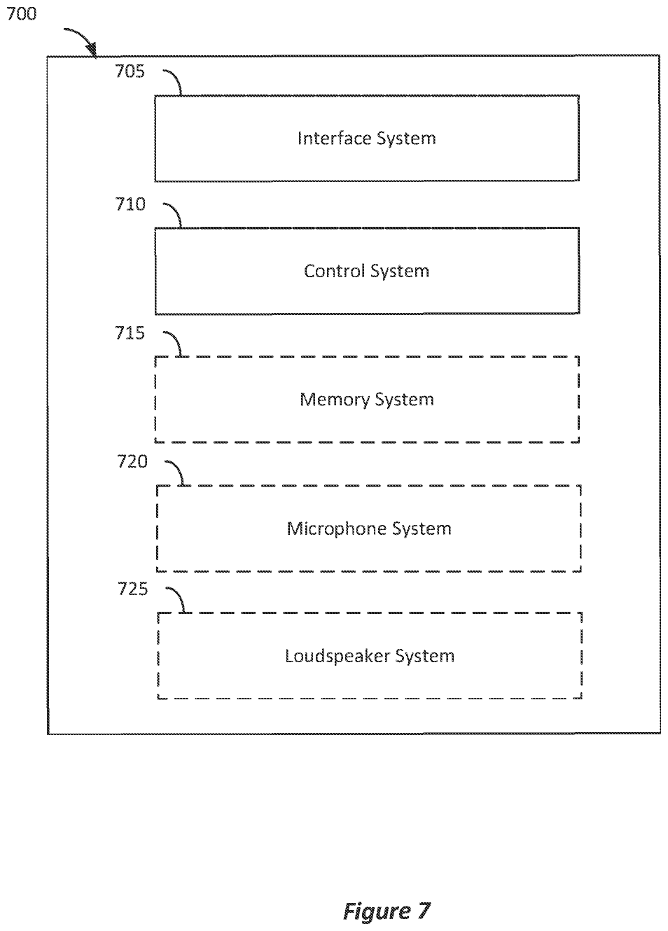

FIG. 1 is a block diagram of an example system 100 for sound field rotation in accordance with some embodiments. As illustrated, system 100 includes a user orientation system 102, a sound field orientation system 104, and a sound field rotation system 106. Note that the various components of system 100 may be implemented by one or more processors disposed in or on headphones worn by the user, one or more processors or controllers of a user device paired with the headphones (e.g., a user device that is presenting the content played back by the headphones), or the like. Examples of such processors or controllers are shown in and described below in connection with FIG. 7.

In some implementations, user orientation system 102 may be configured to determine an orientation of a listener's head. For example, the orientation of the listener's head may be considered a direction in which the listener's nose is pointing. The orientation of the listener's head is generally represented herein as αₙₒₛₑ. The orientation of the listener's head may be determined using one or more inertial sensors, e.g., disposed in or on headphones of the listener. The inertial sensors may include one or more accelerometers, one or more gyroscopes, one or more magnetometers, or the like. In some examples, the orientation of the listener's head may be determined with respect to an external reference frame.

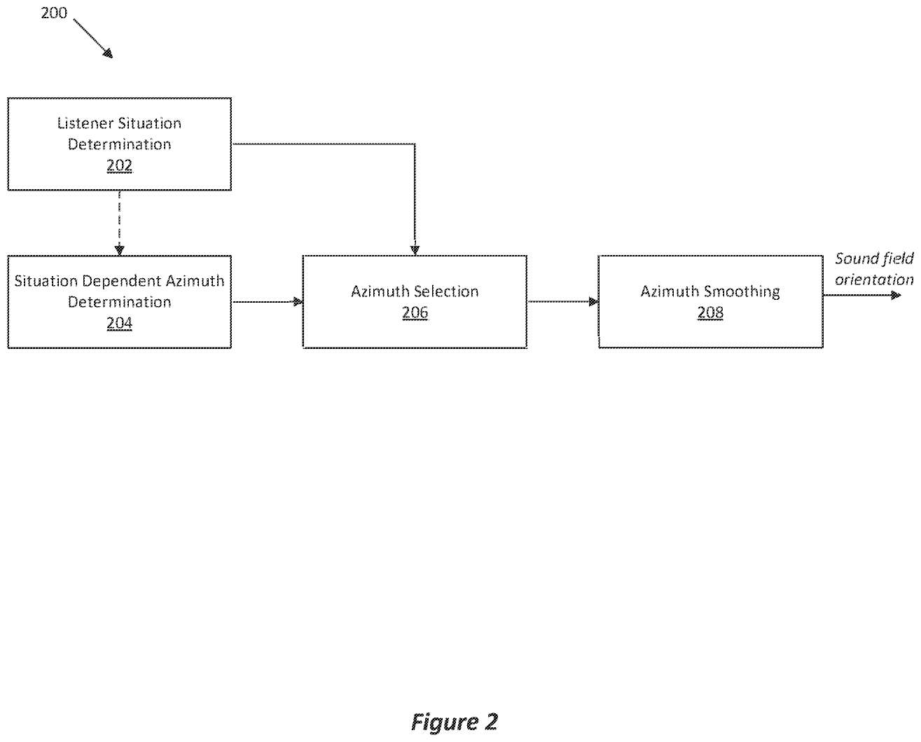

As illustrated, system 100 may include a sound field orientation system 104. Sound field orientation system 104 may be configured to determining a forward-facing direction of the sound field. The forward-facing direction of the sound field is generally represented herein as α_{fwd}. In some implementations, the forward-facing direction of the sound field may be determined based on a current listener situation, or a current activity the listener is engaged in. Example activities include walking, running, riding a bicycle, riding in a vehicle such as a car or bus, remaining substantially still (e.g., while watching television, reading a book, etc.), or participating in a non-walking or non-running movement (e.g., loading the dishwasher, unpacking groceries, various chores, non-walking or non-running exercise activities such as lifting weights, etc.). More detailed techniques for determining the forward-facing direction of the sound field based on the current listener activity are shown in and described below in connection with FIGS. 2 and 4-6.

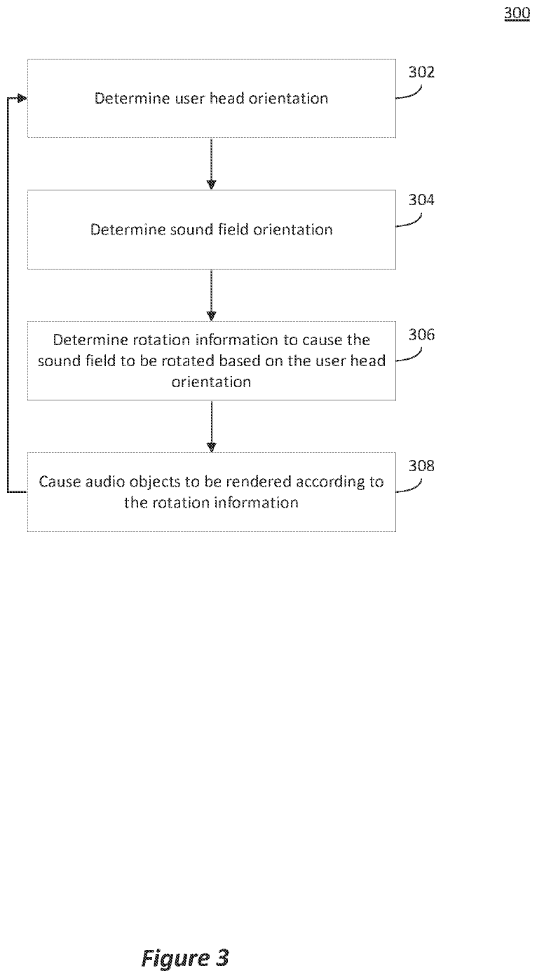

As illustrated, system 100 may include a sound field rotation system 106. Sound field rotation system 106 may be configured to use the orientation of the listener's head determined by user orientation system 102 and the forward-facing direction of the sound field determined by sound field orientation system 104 to rotate the sound field. For example, the sound field may be rotated such that the listener experiences various audio objects, when rendered based on the rotated sound field, as being in front of the listener's head even when the listener moves around. More detailed techniques for rotating the sound field are shown in and described below in connection with FIG. 3.

In some implementations, a forward-facing sound field orientation (generally represented here in as α_{fwd}) may be determined based on a determination of a current listener situation. The current listener situation may indicate, for example, a characterization of a current listener activity. In particular, the characterization of the current listener activity may indicate whether or not the listener is currently moving and/or a type of movement the user is engaged in. Example activities include: walking, running, riding a bicycle, riding in a vehicle such as a car or a bus, being substantially still (e.g., while watching television or reading a book), and/or engaging in non-walking and non-running movement (e.g., loading or unloading the dishwasher, unpacking groceries, doing yardwork, etc.). In some embodiments, a listener situation or activity situation may include a classification of a listener activity in one of a set of possible listener situations. For example, the set may include: 1) walking or running movement; 2) being substantially still; and 3) non-walking and non-running movement. In some embodiments, a set of situation dependent sound field azimuth orientations may be determined, where each situation dependent sound field azimuth orientation corresponds to a possible listener situation. In other words, in some embodiments, multiple possible sound field azimuth orientations may be determined. A sound field azimuth orientation from the set of possible sound field azimuth orientations may then be selected based on the current listener situation. After selection of the sound field azimuth orientation, the final sound field orientation (e.g., as used to rotate the sound field, as described above in connection with FIG. 1) may be determined by smoothing the selected sound field azimuth orientation based on recent previous sound field orientations. In some embodiments, the smoothing may be based on the current listener situation.

FIG. 2 is a block diagram of an example system 200 for determining a forward-facing sound field orientation in accordance with some embodiments. Note that system 200 is an example implementation of sound field orientation system 104 shown in and described above in connection with FIG. 1. As illustrated, system 200 includes a listener situation determination block 202, a situation dependent azimuth determination block 204, an azimuth selection block 206, and an azimuth smoothing block 208. Note that the various components of system 200 may be implemented by one or more processors disposed in or on headphones worn by the user, one or more processors or controllers of a user device paired with the headphones (e.g., a user device that is presenting the content played back by the headphones), or the like. Examples of such processors or controllers are shown in and described below in connection with FIG. 7.

In some embodiments, listener situation determination block 202 may be configured to determine a current listener situation. As described, example listener situations include walking, running, riding a bicycle, riding in a vehicle such as a car or a bus, being substantially still (e.g., while watching television or reading a book), and/or engaging in non-walking and non-running movement (e.g., loading or unloading the dishwasher, unpacking groceries, doing yardwork, etc.). In some embodiments, listener situation determination block 202 may determine the current listener situation based on sensor data from one or more inertial sensors, such as one or more accelerometers, one or more gyroscopes, one or more magnetometers, etc. The inertial sensor(s) may be disposed in or on headphones being worn by the listener. In some implementations, the listener situation may be determined by providing the sensor data to one or more machine learning models trained to output or classify the input sensor data to one of a set of possible listener situations.

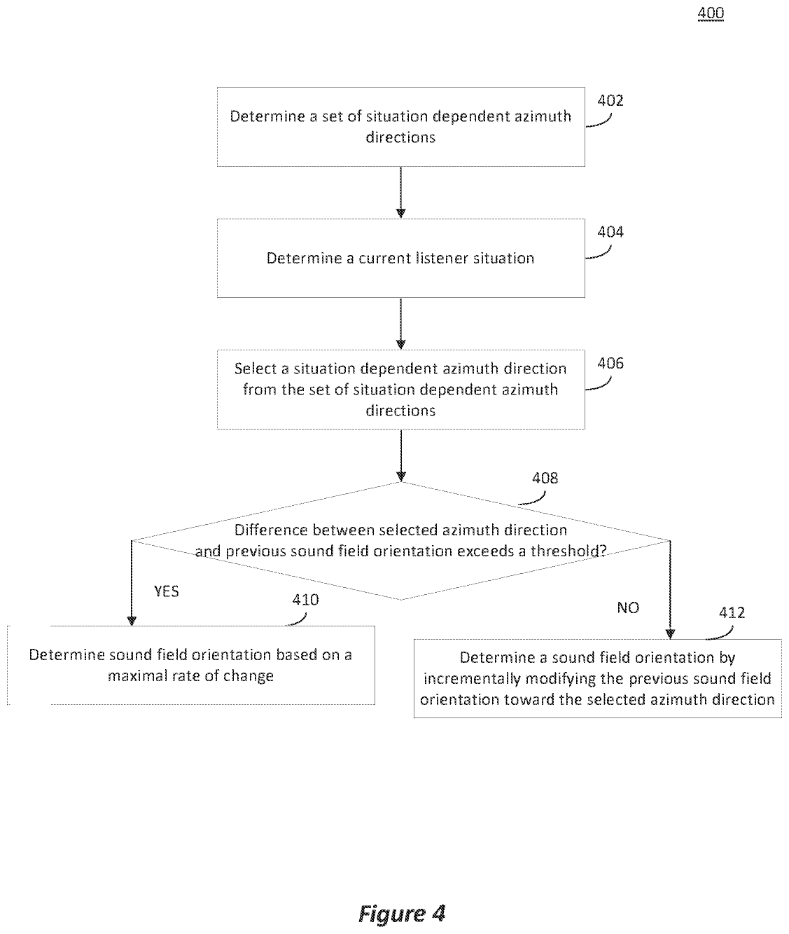

Situation dependent azimuth determination block 204 may be configured to determine a set of multiple situation dependent sound field orientations. For example, situation dependent azimuth determination block 204 may determine three possible sound field orientations corresponding to: 1) a walking or running sound field orientation; 2) a static sound field orientation; and 3) a non-walking and non-running sound field orientation. In some embodiments, the situation dependent sound field orientations may be determined based on the current listener situation, as illustrated in FIG. 2. More detailed techniques for determining the multiple situation dependent sound field orientations are shown in and described below in connection with FIGS. 4-6.

Azimuth selection block 206 may select one of the situation dependent sound field orientations generated by situation dependent azimuth determination block 204 based on the current listener situation determined by listener situation block 202. For example, in an instance in which the current listener situation is walking or running, azimuth selection block 206 may be configured to choose the situation dependent sound field orientation corresponding to the walking or running sound field orientation.

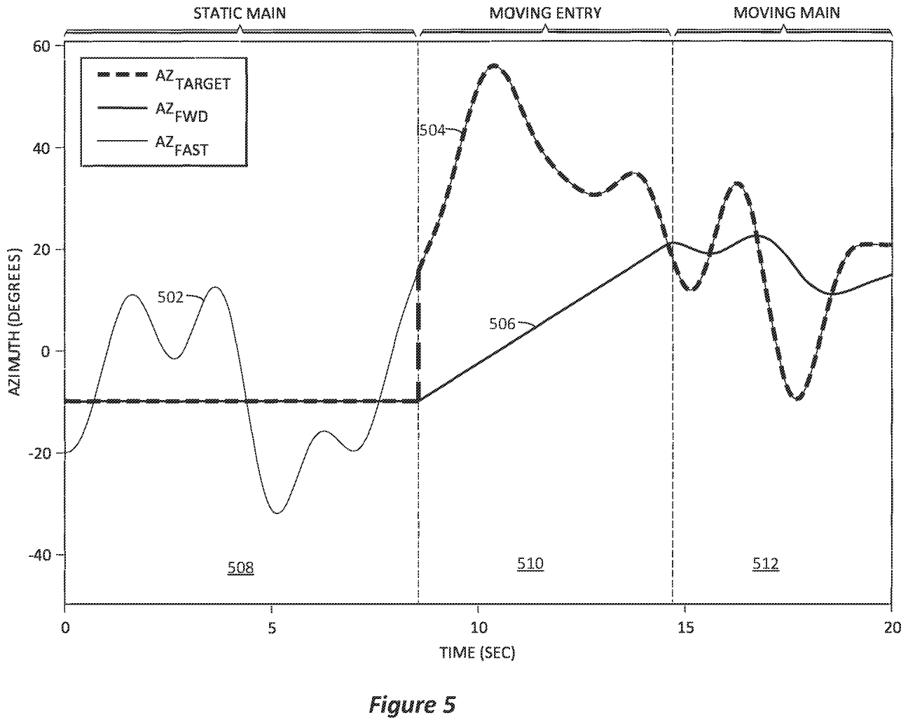

Azimuth smoothing block 208 may be configured to smooth the selected situation dependent sound field orientation based on previous sound field orientations. For example, azimuth smoothing block 208 may utilize a first smoothing technique to smooth the selected situation dependent sound field orientation responsive to determining that the current listener situation is the same as the previous listener situation, and may utilize a second smoothing technique to smooth the selected situation dependent sound field orientation response to determining that the current listener situation is different from the previous listener situation. As another example, azimuth smoothing block 208 may smooth the sound field orientation based on a difference between the current direction of interest and the smoothed representation of the sound field orientation at a previous time sample. Smoothing the sound field orientation based on previous sound field orientations may allow rotation of the sound field to be perceptually smooth, i.e., without causing the sound field to appear to jump from one orientation to another when rotated. Note that, in some embodiments, the sound field orientation may be smoothed based on the current listener situation. For example, the sound field orientation may be rotated with a first slew rate when the current listener situation is walking or running, with a second slew rate when the current listener situation is that the listener is being substantially still, and with a third slew rate when the current listener situation is non-walking and non-running movement. By utilizing different smoothing techniques for different listener situations, the sound field may be rotated in a manner that is desirable for the listener. More detailed techniques for smoothing the sound field orientation are shown in and described below in connection with FIGS. 4 and 5.

In some implementations, a sound field orientation (e.g., as indicated by a front-facing orientation of the sound field) may be determined based on a current orientation of a user's head and a current listener situation. The determined sound field orientation may then be used to identify rotation information (e.g., rotation angles, etc.) to be utilized to cause the sound field to be rotated according to the sound field orientation. In some embodiments, audio objects may then be rendered using the rotation information. For example, rendering the audio objects may involve altering audio data associated with the audio objects to cause the audio objects, when presented, to be spatially perceived in a spatial location with respect to the user's frame of reference that corresponds with an intended spatial location (e.g., as specified by a content creator).

FIG. 3 is a flowchart of an example process 300 for rotating a sound field in accordance with some embodiments. In some implementations, blocks of process 300 may be performed by a processor or a controller. Such a processor or controller may be part of the headphones and/or part of a mobile device paired with headphones, such as a mobile phone, a tablet computer, a laptop computer, etc. An example of such a processor or controller is shown in and described below in connection with FIG. 7. In some embodiments, blocks of process 300 may be performed in an order other than what is shown in FIG. 3. In some implementations, two or more blocks of process 300 may be executed substantially in parallel. In some embodiments, one or more blocks of process 300 may be omitted.

Process 300 can begin at 302 by determining a user head orientation. The user head orientation is generally represented herein as M_{FU}, where M_{FU} is an n-dimensional matrix (e.g., a 3×3 matrix) indicating orientation data with respect to n axes. For example, M_{FU} may be a 3-dimensional matrix indicating orientation data with respect to the X, Y, and Z axes. The user's head orientation may be determined using one or more sensors that are disposed in or on headphones the user is wearing. The sensors may include one or more accelerometers, one or more gyroscopes, one or more magnetometers, or any combination thereof. It should be noted that the user's head orientation M_{FU}, as well as other parameters described hereinbelow, may be a function of time sample, which is generally represented herein as k. Assuming a sample rate of Fₛ, the time point associated with sample k may be determined by:

$$t = \frac{k}{{F}_{s}}$$

In some implementations, the user's head orientation may be used to determine a direction in which the user's nose points, which is generally represented herein as αₙₒₛₑ. For example, in some embodiments, the vector N_{F}, which represents, in a fixed external frame, the direction in which the user's noise point, may be determined based on the matrix that represents the user's head orientation M_{FU}. For example, in some embodiments, N_{F} may be determined by:

$${N}_{U} = {M}_{F U}^{T} \times ( \begin{matrix}1 \\ 0 \\ 0\end{matrix} )$$

Continuing with this example, in some embodiments, the azimuthal angle in which the user's nose is pointing, represented herein as αₙₒₛₑ, may be determined based on the first and second elements of the N_{F} vector. In one example, αₙₒₛₑ may be determined by:

αₙₒₛₑ=atan2((N_{F})₂,(N_{F})₁)

In instances in which the user's head is tilted, the azimuthal angle in which the user's nose is pointing (αₙₒₛₑ), may be determined based on the angular rotation information of the user's head around the Z axis (e.g., the axis pointing vertically out of the top of the user's head), generally represented herein as ω_{ZU}(k). The angular rotation information may be obtained from any subset, or all, of the sensors used to determine the user's head orientation. The user's head may be determined to be tilted responsive to determining that the user's head is inclined more than a predetermined threshold (e.g., more than 20 degrees from the vertical, more than 30 degrees from the vertical, etc.). In some embodiments, in an instance in which the user's head is determined to be tilted from the vertical (e.g., the user's head is not substantially upright), the azimuthal angle of the user's nose may be determined by:

$${α}_{n o s e} ( k ) = {α}_{n o s e} ( k - 1 ) + \frac{{ω}_{Z U} ( k )}{{F}_{s}}$$

At 304, process 300 can determine a sound field orientation. The sound field orientation may be a forward-facing direction of the sound field. The sound field orientation is generally represented herein as α_{fwd}. The sound field orientation may be determined based on a current listener situation. More detailed techniques for determining the sound field orientation based on the current listener situation are shown in and described below in connection with FIGS. 4-6. Note that, in some embodiments, the sound field orientation may be determined based at least in part on the user head orientation determined at block 302.

At 306, process 300 can determine rotation information to cause the sound field to be rotated based on the user head orientation. In some embodiments, the rotation information may be an n-dimensional matrix (generally represented herein as M_{VF}) that indicates a rotation of a virtual reference frame with respect to a fixed external frame to achieve the sound field orientation determined at block 304. In some embodiments, the rotation information may describe a rotation around a Z axis corresponding to an axis pointing out of the user's head. For example, in some embodiments, the rotation information (e.g., the M_{VF} matrix) may be determined by:

$${M}_{VF} = ( \begin{matrix}cos ( {α}_{fwd} ) & - sin ( {α}_{fwd} ) & 0 \\ sin ( {α}_{fwd} ) & cos ( {α}_{fwd} ) & 0 \\ 0 & 0 & 1\end{matrix} )$$

At 308, process 300 can cause the audio objects to be rendered according to the rotation information. For example, in some embodiments, process 300 can determine an n-dimensional matrix (generally represented herein as M_{VU}) that indicates a rotation of a virtual scene that includes the audio objects with respect to the user's head. The rotation of the virtual scene (including one or more audio objects) with respect to the user's head may be determined based on the user's head orientation (e.g., as determined above in block 302) and the rotation information determined at block 306 that indicates the rotation of the virtual scene with respect to a fixed external frame. For example, the rotation of the virtual scene with respect to the user's head, M_{VU}, may be determined by:

$${M}_{VU} = {M}_{FU} \times {M}_{VF}$$

After determining the M_{VF} matrix, a position of an audio object in the fixed external frame may be determined based on the position of the audio object in the virtual frame and based on the M_{VF} matrix that indicates the rotation of the virtual scene with respect to the fixed external frame. For example, for an audio object located at (xᵥ, yᵥ, zᵥ) in the virtual frame, the location of the audio object with respect to the fixed frame (represented herein as (x_{f}, y_{f}, z_{f})) may be determined by:

$$( \begin{matrix}{x}_{f} \\ {y}_{f} \\ {z}_{f}\end{matrix} ) = {M}_{VF} \times ( \begin{matrix}{x}_{v} \\ {y}_{v} \\ {z}_{v}\end{matrix} )$$

It should be noted that the difference between the direction the user's nose is pointing (e.g., αₙₒₛₑ) and the desired forward-facing direction of the sound field (e.g., α_{fwd}) may be represented herein as α_{UV}, which corresponds to the angle of rotation by which the virtual sound field in which the audio objects are to be rendered is to be rotated with respect to the user's frame of reference. The audio objects may therefore be rendered by rotating the location of the audio objects with respect to the virtual reference frame V around the Z_{V} axis by an angle of α_{UV}.

Process 300 can then loop back to block 302. In some implementations, process 300 can continually loop through blocks 302-308, thereby continually updating the rotation of the sound field based on the listener situation. For example, process 300 may rotate the sound field orientation when the user is walking or running in a first manner (e.g., with a direction of interest corresponding to the direction the user is walking or running in), and then, responsive to determining that the user has changed activities (e.g., to a minimal movement listener situation, or to a non-running and non-walking movement), process 300 can rotate the sound field based on the updated activity situation or listener situation (e.g. to correspond to a direction the user was most recently looking in). In this way, process 300 can adaptively respond to the listener situation by adaptively rotating the sound field based on both the listener situation and the user's current orientation.

In some implementations, rotation of a sound field may be determined based on a current listener situation. For example, a current listener situation may be used to determine a direction of interest. By way of example, in an instance in which the current listener situation is that the user is walking or running (e.g., moving forward in a substantially linear manner), the direction of interest may be the current direction the listener is walking, running, or moving. As another example, in an instance in which the current listener situation is that the listener is engaged in minimal movement (e.g., is sitting or standing still), the direction of interest may correspond to the direction in which the listener has been facing during a recent time window (e.g., within a time window of about 3 seconds-10 seconds). As yet another example, in an instance in which the current listener situation is that the listener is moving but not walking or running (e.g., is engaged in a non-walking or non-running activity such as household chores or the like), the direction of interest may correspond to a direction in which the listener has been facing during a recent time window (e.g., within a time window of about 0.2 seconds-3 seconds). Note that the recent time window used to determine a direction of interest for a non-walking and non-running movement activity may be relatively shorter than a time window used to determine the direction of interest for a static or minimal movement listener situation. Note that, in some implementations, multiple directions of interest, each corresponding to a different possible listener situation, may be determined. These directions may sometimes be referred to herein as an azimuthal direction, indicating an azimuthal orientation the listener is interested in and/or is attending to. In some embodiments, a direction of interest from a set of candidate directions of interest may be determined, e.g., based on a determination of the current listener situation or current listener activity. The sound field rotation direction may then be determined based on the selected direction of interest. For example, the rotation of the sound field may be determined in a manner that smooths the sound field rotation toward the selected of direction of interest. The smoothing may be performed by considering whether the current listener situation differs from the previous listener situation in order to more smoothly rotate the sound field, thereby ameliorating discontinuous rotations of the sound field.

FIG. 4 is a flowchart of an example process 400 for determining a sound field rotation in accordance with some embodiments. For example, using the notation generally used herein, process 400 may be utilized to determine the azimuthal sound field orientation, or a front-facing direction of the sound field, which is generally referred to herein as afwd. As a more particular example, FIG. 4 illustrates an example technique that may be used in, e.g., block 304 of FIG. 3 to determine the sound field orientation. Blocks of process 400 may be performed by one or more processors or controllers, e.g., disposed in or on the headphones, or processors or controllers of a user device (e.g., a mobile phone, a tablet computer, a laptop computer, a desktop computer, a smart television, a video game system, etc.) that is paired with headphones being worn by the user. In some embodiments, blocks of process 400 may be performed in an order other than what is shown in FIG. 4. In some implementations, two or more blocks of process 400 may be performed substantially in parallel. In some implementations, one or more blocks of process 400 may be omitted.

Process 400 can begin at 402 by determining a set of situation dependent azimuth directions. Each situation dependent azimuth direction may indicate a possible direction of interest of the user. For example, each situation dependent azimuth direction may indicate a direction the user is predominantly looking, facing, moving toward, or the like. Each situation dependent azimuth direction may correspond to a particular listener situation or activity situation. For example, the set of situation dependent azimuth directions may include a first direction corresponding to a first activity, a second direction corresponding to a second activity, a third direction corresponding to a third activity, etc. The set of situation dependent azimuth directions may include any suitable number of directions, e.g., 1, 2, 3, 5, 10, 20, etc.

In one example, the set of situation dependent azimuth directions may include a first direction corresponding to a listener situation or activity of walking or running (or any other substantially linear forward movement activity), a second direction corresponding to a listener situation or activity of minimal movement, and a third direction corresponding to a listener situation or activity of non-walking or non-running movement (e.g., performing household chores, etc.). Note that an activity of minimal movement generally relates to minimal movement with respect to the listener's frame of reference. For example, a listener who is riding in a bus or other vehicle may be considered to have a listener situation of minimal movement responsive to a determination that the listener is substantially still while riding in the bus or other vehicle, even if the vehicle is itself in movement.

In an instance in which the set of situation dependent azimuth directions includes a running or walking direction of interest (generally represented herein as α_{walk}), the running or walking direction of interest may be determined as the current direction in which the listener is walking or running. The current direction in which the listener is walking or running may be determined using various techniques, for example, using one or more sensors disposed in or on the headphones worn by the listener. The one or more sensors may include one or more accelerometers, one or more gyroscopes, one or more magnetometers, or any combination thereof.

In an instance in which the set of situation dependent azimuth directions includes a minimal movement direction of interest (generally represented herein as Astatic), the minimal movement direction of interest may be determined as the direction the listener has been predominantly facing within a recent time window corresponding with minimal movement of the listener. Example time windows include 3 seconds-10 seconds, 2 seconds-12 seconds, 5 seconds-15 seconds, 5 seconds-20 seconds, or the like. In some embodiments, the minimal movement direction of interest may be determined using information indicating movement of a device the headphones are paired with, e.g., a mobile phone, a tablet computer, a laptop computer, etc. For example, the movement of the paired device may indicate movement of a vehicle the listener is currently riding in. By accounting for movement of the paired device, the sound field may be rotated in a manner that considers, e.g., a vehicle the listener is riding in turning. More detailed techniques for determining a minimal movement direction of interest are shown in and described below in connection with FIG. 5.

In an instance in which the set of situation dependent azimuth directions includes a non-walking and non-running movement (e.g., movement that includes tilting, turning, etc. rather than substantially linear and/or forward motion), the non-walking and non-running direction of interest may be determined as the direction in which the user is currently facing, or has been facing in a recent time window. Examples of time windows include 0.2 seconds-3 seconds, 0.1 seconds-4 seconds, or the like. Note that a time window used to determine a direction of interest for a non-walking and non-running movement may be shorter than a time window used to determine a direction of interest for a minimal movement listener situation. In some embodiments, the time window used to determine the direction of interest for non-walking and non-running movement may be an order of magnitude shorter than the time window used to determine the direction of interest for a minimal movement listener situation.

At 404, process 400 can determine a current listener situation. The current listener situation may be determined based on a sensor data obtained from one or more sensors disposed in or on headphones being worn by the listener. The one or more sensors may include one or more accelerometers, one or more gyroscopes, one or more magnetometers, or any combination thereof. The sensor data may indicate current movement of the listener, a current direction of movement, a current orientation, or the like. In some implementations, the current listener situation may be determined by providing the sensor data to a trained machine learning model configured to output a classification indicative of a likely current listener situation from a set of possible current listener situations. Note that the set of possible current listener situations may correspond to the set of situation dependent azimuth directions. For example, in an instance in which the set of situation dependent azimuth directions includes a walking or running direction of interest, a minimal movement direction of interest, and a non-walking or non-running movement direction of interest, the set of possible current listener situations may include walking or running, minimal movement, and non-walking or non-running movement.

In some embodiments, the current listener situation may be determined based at least in part on data from a user device paired with the headphones being worn by the user. For example, the data from the user device may include whether the user is currently or has recently interacted with the user device, current movement information provided by motion sensors or GPS sensors of the user device (which may indicate that the user device is currently in a moving vehicle, that the user device is currently moving in a direction and/or at a speed that suggests the listener is running or walking, or the like). In some embodiments, the current listener situation may be determined based at least in part on data obtained from microphones, cameras, or other sensors of a paired user device. The user device may include mobile devices (e.g., a mobile phone, a tablet computer, a laptop computer, a vehicle entertainment system, etc.) and non-mobile devices (e.g., a desktop computer, a television, a video game system, etc.).

At 406, process 400 can select a situation dependent azimuth direction from the set of situation dependent azimuth directions. For example, process 400 can select the situation dependent azimuth direction that corresponds to the current listener situation determined at block 404. By way of example, in an instance in which the current listener situation corresponds to walking or running movement, process 400 can select the situation dependent azimuth direction that corresponds to walking or running activity (e.g., which may correspond to the direction the listener is currently walking or running, as determined at block 402). The selected situation dependent azimuth direction is generally represented herein as α_{target}. The selected situation dependent azimuth direction may be considered a selected direction of interest.

At 408, process 400 can determine whether the difference between the selected azimuth direction (e.g., α_{target} (k)) and the previous sound field orientation (e.g., α_{fwd}(k−1)) exceeds a predetermined threshold. For example, in some embodiments, process 400 can determine a difference between the selected situation dependent azimuth angle (e.g., α_{target} (k)) and the previous sound field orientation (e.g., α_{fwd}(k−1)). In one example, process 400 may determine the difference γ(k) by:

$$γ ( k ) = ModC ( {α}_{target} ( k ) - {α}_{fwd} ( k - 1 ) )$$

In the equation given above, the ModC( ) function may serve to remove the effect of periodic angular wrap-around by causing a given angle to be transformed to be within a range of [−180, 180). In one example, ModC(x) may be determined as:

$$ModC ( x ) = mod ( x + 180 , 360 ) - 180$$

In some embodiments, process 400 may determine that the current listener situation is different than the previous listener situation if γ(k) exceeds a predetermined threshold. The predetermined threshold may be +/−3 degrees, +/−5 degrees, +/−10 degrees, +/−15 degrees, or the like.

If, at 408, process 400 determines that the difference between the selected azimuth direction and the previous sound field orientation exceeds the predetermined threshold (“yes” at 408), process 400 can proceed to block 410 and can determine the sound field orientation based on a maximal rate of change of the sound field orientation. For example, in some implementations, process 400 can determine a sound field rotation angle rate based on a maximally allowed angular velocity of the direction of interest. In some embodiments, the sound field rotation angle rate, generally represented herein as δ_{fwd} (k), may be determined as a fixed angular rate based on the maximally allowed angular velocity. Note that the sound field rotation angle rate may indicate the amount that the sound field orientation (e.g., α_{fwd}) changes per sample period. This may allow the angular speed in the sound field orientation (e.g., α_{fwd}) to change (e.g., based on changes in the user's head orientation and/or changes in the listener's situation) smoothly and without jumps in the sound field orientation that may be perceived by the listener as discontinuous and/or jumpy. In one example, the sound field rotation angle rate may be a constant that is dependent on a maximally allowed angular velocity, generally represented herein as ω_{cap}. Example maximal allowed angular velocities are 10 degrees per second, 30 degrees per second, 50 degrees per second, or the like. In one example, the sound field rotation angle rate may be determined by:

$${δ}_{fwd} ( k ) = \{ \begin{matrix}\frac{{ω}_{cap}}{{F}_{s}} when γ ( k ) > 0 \\ \frac{- {ω}_{cap}}{{F}_{s}} when γ ( k ) < 0\end{matrix}$$

The sound field orientation, α_{fwd}(k), may then be determined based on the previous sound field orientation (e.g., α_{fwd}(k−1)) and the sound field rotation angle rate (e.g., δ_{fwd} (k)). For example, in some implementations, the sound field orientation at the current time may be determined by modifying the previous sound field orientation based on the determined sound field rotation angle rate. By way of example, in some implementations, the sound field orientation at the current time may be determined by:

$${α}_{fwd} ( k ) = {α}_{fwd} ( k - 1 ) + {δ}_{fwd} ( k )$$

Conversely, if, at 408, process 400 determines that the selected azimuth direction and the previous sound field orientation does not exceed the predetermined threshold (“no” at 408), process 400 can proceed to block 412 and can determine the sound field orientation at the current time (e.g., α_{fwd} (k)) by modifying the previous sound field orientation (e.g., α_{fwd} (k−1)) toward the selected azimuth direction (e.g., α_{target} (k)). For example, the sound field rotation angle rate δ_{fwd} (k) may be determined based on a combination of the difference between the selected azimuth direction and the previous sound field orientation (e.g., γ(k)) and a smoothing time constant (generally represented herein as τ_{cap}). In some embodiments, τ_{cap} may be within a range of about 0.1-5 seconds. Example values of τ_{cap} include 0.1 seconds, 0.5 seconds, 2 seconds, 5 seconds, or the like. The smoothing time constant may ensure that the updated sound field orientation is changed from the previous sound field orientation in a relatively smooth manner that generally tracks the changing situational direction of interest. In one example, the sound field rotation angle rate may be determined by:

$${δ}_{fwd} ( k ) = \frac{γ ( k )}{1 + {τ}_{cap} {F}_{s}}$$

Similar to what is described above in connection with block 410, the sound field orientation, α_{fwd} (k), may then be determined based on the previous sound field orientation (e.g., α_{fwd} (k−1)) and the sound field rotation angle rate (e.g., δ_{fwd} (k)). For example, in some implementations, the sound field orientation at the current time may be determined by modifying the previous sound field orientation based on the determined sound field rotation angle rate. In particular, in some implementations, the sound field orientation may be determined by updating the previous value of the sound field orientation based on the rate of change of the sound field orientation per sample field (e.g., δ_{fwd} (k)). By way of example, in some implementations, the sound field orientation at the current time may be determined by:

$${α}_{fwd} ( k ) = {α}_{fwd} ( k - 1 ) + {δ}_{fwd} ( k )$$

FIG. 5 is an example chat depicting changes in the sound field orientation based on listener situation in accordance with some embodiments, Note that curve 502 (represented as az_{fast} in FIG. 5) represents the user orientation as a function of time, curve 504 (represented as az_{target} in FIG. 5) represents the selected azimuthal direction based on the current listener situation (e.g., the selected direction of interest), and curve 506 (represented as az_{fwd} in FIG. 5) represents the determined sound field orientation. During time period 508, the listener is in a static, or minimal movement listening situation. Accordingly, even though the user's head orientation (as depicted by curve 502) is moving within about +/−20 degrees, the selected azimuthal direction (as represented by curve 504) remains static during time window 508. Because there is no change in the selected azimuthal direction during time window 508, the sound field orientation (as represented by curve 506) exactly tracks the selected azimuthal direction (note that curve 504 and curve 506 overlap during time window 508).

Turning to time window 510, the listener situation changes to non-walking or non-running movement activity. Note that there is a relatively large and sudden change in the user's head orientation, as represented by curve 502 within time window 508. Because the direction of interest during a non-walking or non-running movement activity generally tracks the user's head orientation, the selected azimuthal direction (represented by curve 504) generally tracks the user's head orientation (note that curve 502 and curve 504 substantially overlap during time window 510). However, during time window 510, because the difference between the selected azimuthal direction (represented by curve 504) and the previous sound field orientation (represented by curve 506) exceeds a threshold, the sound field orientation is incrementally adjusted toward the selected azimuthal direction. In particular, note that curve 506 ramps toward curve 504 during time window 510. The time window during which the sound field orientation is incrementally adjusted toward the selected azimuthal direction is sometimes referred to herein as an “entry state” or a “non-captured state.”

Turning to time window 512, the sound field orientation (represented by curve 506) has now coincided with the selected azimuthal direction (represented by curve 504). Accordingly, the sound field orientation is then generally adjusted to coincide with the most recent direction the user has been facing within a previous time window. Note that, during time window 512, the sound field orientation is adjusted in a manner that generally tracks the user's orientation in a smoothed manner. This time window is sometimes referred to herein as the “main state” or the “captured state.”

In some embodiments, a situation dependent azimuth direction in an instance for a static, or minimal movement, listening situation may be determined such that the azimuth direction correspond to the direction the user has been facing within a recent time window. In some embodiments, a smoothed representation (e.g., smoothed over time) of the user's head orientation may be determined, and the situation dependent azimuth direction may generally track the smoothed representation of the user's head orientation, thereby allowing the azimuth direction to track the user's orientation smoothly. In situations in which the user's head orientation suddenly changes by more than a predetermined threshold, the smoothed representation of the user's head orientation may jump in a discontinuous manner. However, in such instances, the azimuth direction may be determined based on the previous azimuth direction to provide for smoothing in the sound field orientation regardless of discontinuous jumps in the user's head orientation. In some embodiments, the smoothed representation of the user's head orientation may be determined based on the angular velocity of a paired user device (e.g., a paired mobile phone, a paired tablet computer, a paired laptop computer, etc.). For example, the paired user device may be paired with the headphones worn by the user to, e.g., present video or audio content. By utilizing angular velocity measurements from the paired device, the user's head orientation, and consequently, the azimuth direction, may be modified to account for changes in the user's orientation with respect to the external (e.g., fixed) reference frame. For example, utilizing angular velocity measurements from the paired user device may allow for the sound field to be rotated when, e.g., the user is in a vehicle that has turned or has otherwise changed directions.

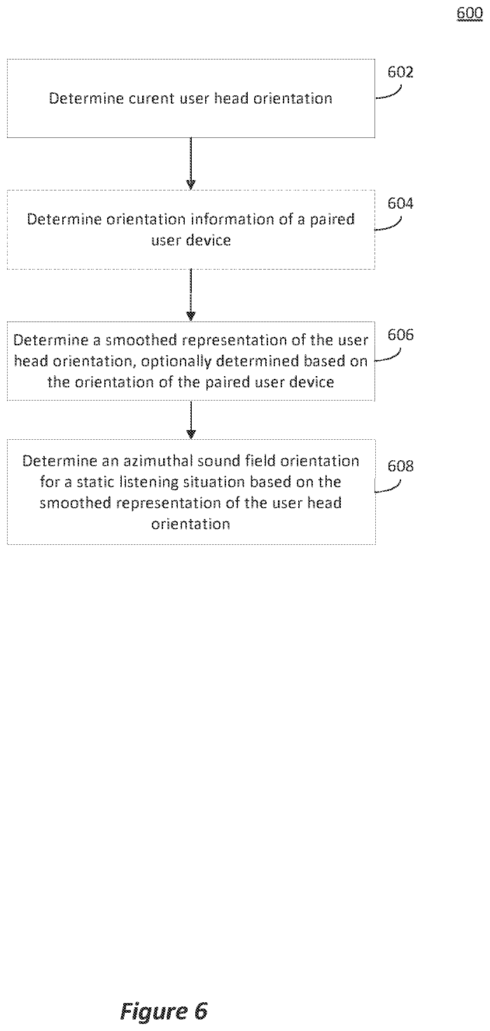

FIG. 6 is a flowchart of an example process 600 for determining a situation dependent azimuth direction for a static listening situation in accordance with some embodiments. In some embodiments, blocks of process 600 may be performed by a processor or controller of headphones worn by the listener, or a processor or a controller of a user device paired with the headphones worn by the listener. Examples of such a processor or controller are shown in and described below in connection with FIG. 7. In some implementations, blocks of process 600 may be performed in an order other than what is shown in FIG. 6. In some embodiments, two or more blocks of process 600 may be performed substantially in parallel. In some embodiments, one or more blocks of process 600 may be omitted.

Process 600 can begin at block 602 by determining a current user head orientation. The current user head orientation is generally represented herein as anose. As described above, the current user head orientation may be determined from one or more sensors disposed in or on headphones worn by the user. The one or more sensors may include one or more accelerometers, one or more gyroscopes, one or more magnetometers, or any combination thereof.

In some embodiments, at 604, process 600 can determine orientation information of a paired user device (e.g., paired with the headphones worn by the listener). Examples of the paired user device include a mobile phone, a tablet computer, a laptop computer, or the like. The orientation information may include the angular velocity of the user device, represented by the angular velocity components around the x, y, and z axes of the fixed external frame by ω_{dev, x}, ω_{dev, y}, and ω_{dev, z}, respectively. The angular velocity information may indicate whether the user device moves with respect to the external (e.g., fixed) frame. For example, such angular velocity information may indicate motion of a vehicle the listener is in as it moves and/or turns. The angular velocity information may indicate whether the user device is currently being used and/or handled by the listener. An azimuth contribution of the paired user device may then be determined, where the azimuth direction is represented as ω_{dev} (k). In one example, the azimuth contribution may be determined by:

$${ω}_{dev} ( k ) = \{ \begin{matrix}0 , & when {{ω}_{dev , X} ( k )}^{2} + {{ω}_{dev , Y} ( k )}^{2} > {ω}_{dev \_ max \_ tilt}^{2} \\ {( {T}_{F} ( k ) )}_{3} \times {ω}_{dev , Z} ( k ) & otherwise\end{matrix}$$

In the equation given above, ω_{dev_max_tilt} represents the maximum permissible angular velocity of tilting of the companion device. T_{F} (k)₃ represents the third element of the vector T_{F} (k), which represents the direction, with respect to the fixed external frame of reference, that the top of the user's head in pointing.

When a companion device is not being handled during normal motion of a vehicle, the angular velocity of turning of the vehicle may be indicated by ω_{dev,Z} (k). In some embodiments, excessive tilting of the device, as indicated by large non-zero values of ω_{dev,X} (k) and ω_{dev,Y} (k), may indicate that the device is being handled by the user. In some embodiments, values of the threshold ω_{dev_max_tilt}, to detect tilting of the companion device, may be within a range of about 10 degrees per second-200 degrees per second. In one embodiment, ω_{dev_max_tilt} is 60 degrees per second.

At 606, process 600 can determine a smoothed representation of the user's head orientation (generally represented herein α_{follow}(k)). For example, in some embodiments, process 600 may first determine a difference between the user's current head orientation (e.g., αₙₒₛₑ (k)) and the smoothed representation of the user's head orientation at a previous time point (generally represented herein as α_{follow} (k−1)). For example, the difference, generally represented herein as δ_{follow} (k), may be determined by:

$${δ}_{follow} ( k ) = ModC ( {α}_{nose} ( k ) - {α}_{follow} ( k - 1 ) )$$

The ModC function, as described above in connection with FIG. 4, may cause the difference angle to be bounded within the range of [−180 degrees, 180 degrees).

The smoothed representation of the user's head orientation may then be determined based on the difference between the user's current head orientation and the smoothed representation of the user's head orientation at the previous time point. For example, in instances in which the difference is less than a predetermined threshold (generally represented herein as δ_{follow_max}), the smoothed representation of the user's head orientation may be modified to generally track the difference with a smoothing time constant. Conversely, in instances in which the difference is more than the predetermined threshold, the smoothed representation of the user's head orientation may be set to discontinuously jump to the user's current head orientation. Examples of the predetermined threshold (e.g., δ_{follow_max}) are 2 degrees, 5 degrees, 10 degrees, 15 degrees, 20 degrees, 25 degrees, or the like. In one example, the smoothed representation of the user's head orientation may be determined by:

$${α}_{follow} ( k ) = \{ \begin{matrix}{α}_{nose} ( k ) & when \vert {δ}_{follow} ( k ) \vert \geq {δ}_{follow \_ max} \\ {α}_{follow} ( k - 1 ) + \frac{{δ}_{follow} ( k )}{1 + {τ}_{follow} {F}_{s}} & otherwise\end{matrix}$$

In the equation given above, τ_{follow} may have a value within a range of about 5 seconds and 50 seconds, such as 10 seconds, 20 seconds, 30 seconds, or the like.

In an instance in which orientation information of the paired user device is obtained at block 604, process 600 may utilize the orientation information to determine the smoothed representation of the user's head orientation. For example, in some embodiments, process 600 may incorporate the azimuthal contribution to the angular velocity of the paired user device in the smoothed representation of the user's head orientation. As a more particular example, the smoothed representation of the user's head orientation may be incrementally adjusted toward the user's current orientation and toward the direction of movement of the paired user device. In one example, the smoothed representation of the user's head orientation may be determined by:

$${α}_{follow} ( k ) = \{ \begin{matrix}{α}_{nose} ( k ) & when \vert {δ}_{follow} ( k ) \vert \geq {δ}_{follow \_ max} \\ {α}_{follow} ( k - 1 ) + \frac{{δ}_{follow} ( k )}{1 + {τ}_{follow} {F}_{s}} + \frac{{ω}_{dev} ( k )}{{F}_{s}} & otherwise\end{matrix}$$

At 608, process 600 can determine an azimuthal sound field orientation for a static (e.g., minimal movement) listening situation based on the smoothed representation of the user's head orientation. Note that the azimuthal sound field orientation for the static listening situation is generally referred to herein as α_{static}, and may be included in the set of situation dependent azimuth sound field orientations, as shown in and described above in connection with FIG. 4. For example, in instances in which the difference (generally represented herein as δ_{follow} (k)) between the user's current head orientation and the smoothed representation of the user's head orientation at the previous time is less than a predetermined threshold (e.g., a movement tolerance threshold, generally represented herein as δfollow_max), the azimuthal sound field orientation may be set to the smoothed representation of the user's head orientation at the current time. In one example, the azimuthal sound field orientation may be determined by:

$$When \vert {δ}_{follow} ( j ) \vert < {δ}_{follow \_ max} ∀ j ε \vert k - {T}_{static} {F}_{s} , k \vert \text{:}$$

$${α}_{static} ( k ) = {α}_{follow} ( k )$$

$$Otherwise \text{:} {α}_{static} ( k ) = {α}_{static} ( k - 1 )$$

In an instance in which orientation information from the paired user device is obtained (e.g., at block 604), the azimuthal sound field orientation may be determined based at least in part on the azimuthal contribution of the angular velocity of the paired user device. In some embodiments, the angular velocity of the paired user device may be utilized only in instances in which the difference between the user's head orientation at the current time and the smoothed representation of the user's head orientation at the previous time exceeds the predetermined threshold (e.g., δ_{follow_max}). In other words, the angular velocity of the paired user device may be used to update the azimuthal sound field orientation in instances in which there is a relatively large change in the user's head orientation. In one example, in instances in which the difference between the user's head orientation at the current time and the smoothed representation of the user's head orientation at the previous time exceeds the predetermined threshold (e.g., δ_{follow_max}), the azimuthal sound field orientation may be determined by:

$${α}_{static} ( k ) = {α}_{static} ( k - 1 ) + \frac{{ω}_{dev} ( k )}{{F}_{s}}$$

As described above, the azimuthal sound field orientation for the static listening situation, Ostatic, may then be used as a possible situation dependent azimuthal sound field orientation that may be selected dependent on a current listener situation, as shown in and described above in connection with FIG. 4.

FIG. 7 is a block diagram that shows examples of components of an apparatus capable of implementing various aspects of this disclosure. As with other figures provided herein, the types and numbers of elements shown in FIG. 7 are merely provided by way of example. Other implementations may include more, fewer and/or different types and numbers of elements. According to some examples, the apparatus 700 may be configured for performing at least some of the methods disclosed herein. In some implementations, the apparatus 700 may be, or may include, a television, one or more components of an audio system, a mobile device (such as a cellular telephone), a laptop computer, a tablet device, a smart speaker, or another type of device.

According to some alternative implementations the apparatus 700 may be, or may include, a server. In some such examples, the apparatus 700 may be, or may include, an encoder. Accordingly, in some instances the apparatus 700 may be a device that is configured for use within an audio environment, such as a home audio environment, whereas in other instances the apparatus 700 may be a device that is configured for use in “the cloud,” e.g., a server.

In this example, the apparatus 700 includes an interface system 705 and a control system 710. The interface system 705 may, in some implementations, be configured for communication with one or more other devices of an audio environment. The audio environment may, in some examples, be a home audio environment. In other examples, the audio environment may be another type of environment, such as an office environment, an automobile environment, a train environment, a street or sidewalk environment, a park environment, etc. The interface system 705 may, in some implementations, be configured for exchanging control information and associated data with audio devices of the audio environment. The control information and associated data may, in some examples, pertain to one or more software applications that the apparatus 700 is executing.

The interface system 705 may, in some implementations, be configured for receiving, or for providing, a content stream. The content stream may include audio data. The audio data may include, but may not be limited to, audio signals. In some instances, the audio data may include spatial data, such as channel data and/or spatial metadata. In some examples, the content stream may include video data and audio data corresponding to the video data.

The interface system 705 may include one or more network interfaces and/or one or more external device interfaces (such as one or more universal serial bus (USB) interfaces). According to some implementations, the interface system 705 may include one or more wireless interfaces. The interface system 705 may include one or more devices for implementing a user interface, such as one or more microphones, one or more speakers, a display system, a touch sensor system and/or a gesture sensor system. In some examples, the interface system 705 may include one or more interfaces between the control system 710 and a memory system, such as the optional memory system 715 shown in FIG. 7. However, the control system 710 may include a memory system in some instances. The interface system 705 may, in some implementations, be configured for receiving input from one or more microphones in an environment.

The control system 710 may, for example, include a general purpose single- or multi-chip processor, a digital signal processor (DSP), an application specific integrated circuit (ASIC), a field programmable gate array (FPGA) or other programmable logic device, discrete gate or transistor logic, and/or discrete hardware components.

In some implementations, the control system 710 may reside in more than one device. For example, in some implementations a portion of the control system 710 may reside in a device within one of the environments depicted herein and another portion of the control system 710 may reside in a device that is outside the environment, such as a server, a mobile device (e.g., a smartphone or a tablet computer), etc. In other examples, a portion of the control system 710 may reside in a device within one environment and another portion of the control system 710 may reside in one or more other devices of the environment. For example, a portion of the control system 710 may reside in a device that is implementing a cloud-based service, such as a server, and another portion of the control system 710 may reside in another device that is implementing the cloud-based service, such as another server, a memory device, etc. The interface system 705 also may, in some examples, reside in more than one device.

In some implementations, the control system 710 may be configured for performing, at least in part, the methods disclosed herein. According to some examples, the control system 710 may be configured for implementing methods of determining a user orientation, determining a user listening situation, or the like.

Some or all of the methods described herein may be performed by one or more devices according to instructions (e.g., software) stored on one or more non-transitory media. Such non-transitory media may include memory devices such as those described herein, including but not limited to random access memory (RAM) devices, read-only memory (ROM) devices, etc. The one or more non-transitory media may, for example, reside in the optional memory system 715 shown in FIG. 7 and/or in the control system 710. Accordingly, various innovative aspects of the subject matter described in this disclosure can be implemented in one or more non-transitory media having software stored thereon. The software may, for example, include instructions for determining a movement direction, determining a movement direction based on a direction orthogonal to the movement direction, etc. The software may, for example, be executable by one or more components of a control system such as the control system 710 of FIG. 7.

In some examples, the apparatus 700 may include the optional microphone system 720 shown in FIG. 7. The optional microphone system 720 may include one or more microphones. In some implementations, one or more of the microphones may be part of, or associated with, another device, such as a speaker of the speaker system, a smart audio device, etc. In some examples, the apparatus 700 may not include a microphone system 720. However, in some such implementations the apparatus 700 may nonetheless be configured to receive microphone data for one or more microphones in an audio environment via the interface system 710. In some such implementations, a cloud-based implementation of the apparatus 700 may be configured to receive microphone data, or a noise metric corresponding at least in part to the microphone data, from one or more microphones in an audio environment via the interface system 710.

According to some implementations, the apparatus 700 may include the optional loudspeaker system 725 shown in FIG. 7. The optional loudspeaker system 725 may include one or more loudspeakers, which also may be referred to herein as “speakers” or, more generally, as “audio reproduction transducers.” In some examples (e.g., cloud-based implementations), the apparatus 700 may not include a loudspeaker system 725. In some implementations, the apparatus 700 may include headphones. Headphones may be connected or coupled to the apparatus 700 via a headphone jack or via a wireless connection (e.g., BLUETOOTH).

Some aspects of present disclosure include a system or device configured (e.g., programmed) to perform one or more examples of the disclosed methods, and a tangible computer readable medium (e.g., a disc) which stores code for implementing one or more examples of the disclosed methods or steps thereof. For example, some disclosed systems can be or include a programmable general purpose processor, digital signal processor, or microprocessor, programmed with software or firmware and/or otherwise configured to perform any of a variety of operations on data, including an embodiment of disclosed methods or steps thereof. Such a general purpose processor may be or include a computer system including an input device, a memory, and a processing subsystem that is programmed (and/or otherwise configured) to perform one or more examples of the disclosed methods (or steps thereof) in response to data asserted thereto.

Some embodiments may be implemented as a configurable (e.g., programmable) digital signal processor (DSP) that is configured (e.g., programmed and otherwise configured) to perform required processing on audio signal(s), including performance of one or more examples of the disclosed methods. Alternatively, embodiments of the disclosed systems (or elements thereof) may be implemented as a general purpose processor (e.g., a personal computer (PC) or other computer system or microprocessor, which may include an input device and a memory) which is programmed with software or firmware and/or otherwise configured to perform any of a variety of operations including one or more examples of the disclosed methods. Alternatively, elements of some embodiments of the inventive system are implemented as a general purpose processor or DSP configured (e.g., programmed) to perform one or more examples of the disclosed methods, and the system also includes other elements (e.g., one or more loudspeakers and/or one or more microphones). A general purpose processor configured to perform one or more examples of the disclosed methods may be coupled to an input device (e.g., a mouse and/or a keyboard), a memory, and a display device.

Another aspect of present disclosure is a computer readable medium (for example, a disc or other tangible storage medium) which stores code for performing (e.g., coder executable to perform) one or more examples of the disclosed methods or steps thereof.

While specific embodiments of the present disclosure and applications of the disclosure have been described herein, it will be apparent to those of ordinary skill in the art that many variations on the embodiments and applications described herein are possible without departing from the scope of the disclosure described and claimed herein. It should be understood that while certain forms of the disclosure have been shown and described, the disclosure is not to be limited to the specific embodiments described and shown or the specific methods described.

1. A method for determining sound field rotations, the method comprising:
(a) determining an activity situation of an activity of a user, wherein the activity situation comprises a characterization of a type of movement of the user while engaged in the activity;
(b) determining a user head orientation using at least one sensor of one or more sensors;
(c) determining a direction of interest based on the activity situation and the user head orientation; and
(d) determining a rotation of a sound field used to present audio objects via headphones based on the direction of interest.

2. The method of claim 1, further comprising (e) repeating (a)-(d) such that the rotation of the sound field is updated over time based on changes in the activity situation of the user and the user head orientation.

3. The method of claim 1, wherein the activity situation comprises at least one of: walking, running, non-walking and non-running movement, or minimal movement.

4. The method of claim 3, wherein the activity situation comprises walking or running, and wherein the direction of interest is determined based on the direction in which the user is walking or running.

5. The method of claim 3, wherein the activity situation comprises non-walking and non-running movement, and wherein the direction of interest is determined based on a direction the user has been facing within a predetermined previous time window.

6. The method of claim 5, wherein the predetermined previous time window is within a range of about 0.2 seconds to 3 seconds.

7. The method of claim 3, wherein the activity situation comprises minimal movement, and wherein the direction of interest is determined based on a direction the user has been facing within a predetermined previous time window.

8. The method of claim 7, wherein the predetermined previous time window is longer than a predetermined previous time window used to determine the direction of interest associated with an activity situation of non-walking and non-running movement.

9. The method of claim 7, wherein the predetermined previous time window used to determine direction of interest associated with an activity situation of minimal movement is within a range of about 3 seconds to 10 seconds.

10. The method of claim 7, wherein the direction the user has been facing is determined using a tolerated threshold of movement, and wherein the tolerated threshold of movement is within a range of 2 degrees to 20 degrees.

11. The method of claim 7, wherein the rotation of the sound field involves an incremental rotation toward the direction of interest.

12. The method of claim 11, wherein the incremental rotation is based at least in part on angular velocity measurements obtained from a user device.

13. The method of claim 12, wherein the user device is substantially static in movement with respect to the headphones worn by the user.

14. The method of claim 12, wherein the user device provides audio content to the headphones.

15. The method of claim 1, wherein the activity situation of the user is determined based at least upon sensor data obtained from one or more sensors disposed in or on headphones worn by the user.

16. The method of claim 1, wherein the user head orientation is determined using at least one sensor disposed in or on headphones worn by the user.

17. (canceled)

18. The method of claim 1, further comprising after (d), causing the audio objects to be rendered based on the determined rotation of the sound field.

19. The method of claim 18, further comprising causing the rendered audio objects to be presented via the headphones.

20. An apparatus comprising: one or more processors; and a memory storing software configured to be executed by the one or more processors, the software including instructions for:
(a) determining an activity situation of an activity of a user, wherein the activity situation comprises a characterization of a type of movement of the user while engaged in the activity;
(b) determining a user head orientation using at least one sensor of one or more sensors;
(c) determining a direction of interest based on the activity situation and the user head orientation; and
(d) determining a rotation of a sound field used to present audio objects via headphones based on the direction of interest.

21. One or more non-transitory media having software stored thereon, the software configured to be executed by one or more processors and including instructions for:
(a) determining an activity situation of an activity of a user, wherein the activity situation comprises a characterization of a type of movement of the user while engaged in the activity;
(b) determining a user head orientation using at least one sensor of one or more sensors;
(c) determining a direction of interest based on the activity situation and the user head orientation; and
(d) determining a rotation of a sound field used to present audio objects via headphones based on the direction of interest.
